(19) United States
(12) Patent Application Publication
(10) Pub. No.: US 2013/0311233 A1
(43) Pub. Date: Nov. 21, 2013

(54) Method for predicting revenue to be generated by a webpage comprising a list of items having common properties

(71) Applicant: Twenga SA, Paris (FR)

(72) Inventors: Martin RAJMAN, Prilly (CH); Romain RIVIÈRE, Paris (FR)

(73) Assignee: Twenga SA, Paris (FR)

(21) Appl. No.: 13/892,510

(22) Filed: May 13, 2013

(51) Int. Cl. G06Q 30/02

(52) U.S. Cl. CPC G06Q 30/0202
USPC 705/7.31

(57) ABSTRACT

The invention provides a method for estimating probabilities of a user clicking on items appearing in a results list obtained by a web search engine to predict the revenue for the results list, the web searching engine being used to search for the items on the web, the results list comprising a plurality of items. Each of the items has one or more properties, whereby at least one property may be common between the item and another item, and whereby the one or more properties each have a determined value. Historical data of users' actions comprises at least for each of the plurality of items or for a set of the plurality of items, a list of displays and clicks on selected items together with their values of properties if available, thus allowing the aggregation of statistics of displays and clicks for each value of properties.

### TECHNICAL FIELD

The invention relates to a method to be used in electronic commerce on the web.

### BACKGROUND

In the field of electronic commerce on the web it is common that users search for items that they wish to purchase using search engines online. A results page produced by a web search engine may be in the form of a list of items presented in a determined order via the user interface. The web search engine may be programmed to attribute a rank to each item of the list hence having a direct influence on the determined order.

The ranking is intended to please the user and increase the probability that the user clicks an item shown within the list and thus proceeds to the purchase thereof. An item with a higher ranking, i.e. an item at the top of the list, would typically be thought to have a higher probability of being clicked on by the user than an item with a lower ranking, i.e. an item at the bottom of the list. The web search engine may be rewarded for each user it successfully sends to a merchant. Hence in order to improve revenue it is desirable to achieve the best possible ranking of the items. As a consequence, it is needed to estimate, with the best possible precision, the click probability or revenue for each item shown within the results list.

Methods for achieving a better ranking, detection of new themes of interest, or the prediction of revenue or click probability for items or pages in the context of search engines, by making use of historical data of users' actions that comprises for each item a frequency of appearance at which users have selected the item in a past period, together with the total number of appearances, has been described in a number of publications. Examples of such publications are given in the list below:
Method and system for dynamic pricing, SRINIVASAN et al. U.S. Pat. No. 7,330,839;
Dynamic pricing of items based on category with which the item is associated, EGLEN et al. U.S. Pat. No. 7,587,372;
Auction result prediction, GHANI et al. U.S. Pat. No. 7,752,119;
Performing predictive pricing based on historical data, ETZIONI et al. U.S. Pat. No. 734,652;
Keyword bidding strategy for novel concepts, Alexandrin Popescul et al. U.S. Pat. No. 7,941,436;
Method For Optimum Placement Of Advertisements On A Webpage, Charles McElfresh et al. U.S. Pat. No. 7,100,111;
INDEX-BASED TECHNIQUE FRIENDLY CTR PREDICTION AND ADVERTISEMENT SELECTION, Deepak K. Agarwal et al. US20110099059;
CLICK PROBABILITY WITH MISSING FEATURES IN SPONSORED SEARCH, Ozgur Cetin et al. US20110246286;
CLICK THROUGH RATE PREDICTION SYSTEM AND METHOD, Looja Tuladhar et al. US20100082421;
Using Clicked Slate Driven Click-Through Rate Estimates in Sponsored Search, Divy Kothiwal et al. US20120136722;
Ad Relevance In Sponsored Search, Dustin Hillard et al. US20110270672; and
Optimizing Advertisement Selection in Contextual Advertising Systems, Wei Li et al. US20110196733.

### SUMMARY OF INVENTION

One aim of the present invention is to provide an accurate estimate of revenue and click probability for individual items as well as for the results list.

The invention provides a method for estimating probabilities of a user clicking on items appearing in a results list obtained by a web search engine in order to predict the revenue for the results list, the web searching engine being used by the user to search for the items on the web, the results list comprising a plurality of items. Each of the items of the plurality of items has one or more properties, whereby at least one of the one or more properties may be common between the item and an other item, and whereby the one or more properties each have a determined value. Historical data of users' actions comprises at least for each of the plurality of items or for a set of the plurality of items, a list of displays and clicks on selected items together with their values of properties if available, thus allowing the aggregation of statistics of displays and clicks for each values of properties, such as the frequency of appearance at which users have selected the item in a past period and a total number of appearances at which users have selected the item in the past period. The method comprises the steps of defining an ordered set of buckets that each may contain one or more items of the plurality of items, whereby the one or more items are selected if they respectively have a subset of properties corresponding to a bucket specific subset of properties and if they respectively satisfy a criteria on their number of appearances in the historical data; computing a bucket specific analysis for each bucket to produce a model; repeating the step of defining an ordered set of buckets and the step of computing a bucket specific analysis to obtain the model until a result of the statistical analysis reaches a determined threshold of convergence; and computing a refinement of the model using a statistical analysis.

In a first preferred embodiment the step of computing a bucket specific analysis is performed for a first bucket and a second bucket, whereby a first statistical analysis is applied for the first bucket, and a second statistical analysis is applied for the second bucket, the second statistical analysis being different from the first statistical analysis; and the method further comprises combining the first bucket specific analysis with the second bucket specific analysis by applying the step of computing a bucket specific analysis to the combination of the first bucket specific analysis and the second bucket specific analysis using a third statistical analysis.

In a second preferred embodiment the first statistical analysis is one of the list comprising a baseline, an EM based method; the second statistical analysis is one of the list comprising a baseline, an EM based method; and the third statistical analysis is a Bayesian based method.

In a third preferred embodiment, the step of computing a bucket specific analysis is performed using a statistical analysis.

In a fourth preferred embodiment the statistical analysis is one of the list comprising a baseline method, an EM based method.

In a fifth preferred embodiment the step of repeating the step of defining one or more buckets and the step of computing a bucket specific analysis to obtain the model are performed using a statistical analysis that comprises a successive usage of a method for searching for an optimal configuration and a method for searching for optimal frequential cut-off values. The method further comprises an associating for each item to a parameter used to aggregate statistics on the user historical data for each value of properties; and carrying out a searching for each dimension, logarithmic in space, increasing or decreasing, until the difference between the two consecutive metric values, or the best found at this stage, is inferior to a certain value, given by the method operator.

In a sixth preferred embodiment the step of computing a refinement of the model is performed by a statistical analysis, the latter comprising a method for local and global recalibration of probabilities/revenues and a method for robustification of probabilities/revenues predictors.

In a seventh preferred embodiment the method for local and global recalibration further comprises re-estimating all probabilities on a new set of historical user actions; carrying out the local recalibration by learning the default probability parameter; and carrying out the global recalibration on the probabilities of all parameters.

In an eighth preferred embodiment the method for robustification further comprises a review of the number of items per bucket which uses a particular local predictor to build an application profile; and a use of a cutoff per bucket to replace the predictor by a generic default predictor.

In a ninth preferred embodiment, the inventive method further comprises the use of a baseline method, wherein the probabilities are estimated using the number of clicks on items corresponding to the parameter as defined in the fifth preferred embodiment herein above described, divided by the number of item displays corresponding to this parameter and the revenues by multiplying the latter with the revenue per click.

In a tenth preferred embodiment the method further comprises the use of an EM based method, wherein the probabilities Pr of each item are estimated using the equation

Pr(item)=Pr(position)*Pr(parameter)

where Pr(position) and Pr(parameter) are estimated using the iterative calculation of a coupling equation, which states

vn+1(r)=(A(r.)+˜Bn (r.))/C(r.)

sn+1(p)=A(.p)/(A(.p)+˜B(.p))

where

X(r.)=Σp {X(r,p)}, X(.p)=Σr {X(r,p)}, and

˜Bn(r,p)=B(r,p)*vn (r)*(1−sn (p))/(1−vn (r)*sn (p))})

In an eleventh preferred embodiment, the inventive method further comprises the use of a Bayesian based method, wherein the Bayesian method is carried out using a beta prior, with the following probability estimation calculation: ˜p(i)=(A(i)+a)/(C(i)+c) where a, c are the beta distribution parameters

a=˜E(p)*c

c=(˜E(p)*(1−˜E(p))/˜V(p))−1

where ˜E(p) (resp. ˜V(p)) are estimates of mean (resp. variance) of beta distribution.

In a twelfth preferred embodiment, the associating is done through the use of a local predictor, the latter further comprising the determination of a low and a high parameter, the choice of parameter being resolved with the number of appearances for a particular value of property associated with the item.

In a thirteenth preferred embodiment, the metric is done by the formula (#predicted_clicks−#observed_clicks)/#observed_clicks for probability estimation and by the formula (#predicted_revenue−#observed_revenue)/#observed_revenue for revenue estimation.

In a fourteenth preferred embodiment the parameters are one of the values of property that are known for the bucket.

In a fifteenth preferred embodiment, the mean and variance of beta distribution are estimated on items for each bucket smaller, according to the order of the inventive method, than another bucket, as defined in the herein above described first preferred embodiment.

Those skilled in the art will appreciate other aspects of the invention based on the discussion that follows and the drawing appended hereto.

### BRIEF DESCRIPTION OF THE FIGURE

The invention will be better understood in view of the description of preferred embodiments given hereafter in combination with the unique FIGURE, wherein

FIG. 1 schematically illustrates a typical technical architectured environment in which the invention may be implemented.

### DETAILED DESCRIPTION OF PREFERRED EMBODIMENTS

The description of the invention set forth below focuses on one or more embodiments of the invention. The embodiments are intended to be exemplary of the invention and not limiting of the scope of the invention. As should be apparent to those skilled in the art, the embodiments described herein present aspects of the invention for which there are numerous variations and equivalents. Those variations and equivalents are intended to be encompassed by the present invention.

Overview

The web is a convenient place to find information about items one wishes to purchase. A common way of going about finding information is to use a general or specialized search engine, which may reside on hardware of a computing system that is part of the web. The search engine accepts search terms proposed by a user and returns a list of website references that may be related to the proposed search term(s). For example, a user searching for a specific camera or a clothes outfit for a special occasion may enter on a search engine keywords such as “ canon eos 550d” and “red evening dress”. . . .

The list of search results returned by the web search engine is represented on a webpage and displayed for the intention of the user. More precisely the webpage contains the list of search results corresponding to a search. The size of the results list can be fixed or variable for all searches. Items displayed within the search results list may exhibit among each other common properties with identical values or not. Examples of common properties include the identifying properties of the item, the item's category, the item's site of origin . . . . As the users execute more and more searches, a user search history is gathered, including information about lists of items displayed and the corresponding properties for these items.

Methods and Process

The invention proposes the following methods and processes:
a method to enable the estimation of the probability of a click on each item on the results page;
a process to calculate the revenue in the case of a user clicking on one of the items shown on the results page;
a method to estimate the probability of a click on a results page;
and a process to predict the revenue of a results page.

The search for the best ranking, new topics of interest, or the prediction of revenue or click probability for items or pages in the context of search engines, using the history of interactions of previous users, has already resulted in many patents such as those listed as prior art herein above. In contrast to the prior art, the present invention distinguishes from known methods and processes by making use of explicit common item properties. These common items properties allow to define buckets, then to refine the predictions by buckets in terms of their frequency according to the users' search history. In particular, the methods according to the invention comprise the use of an EM method, which allows to create a model linked to both the position and the properties of the items present in the pages representing search results; and a Bayesian method, which allows to take into account the intrinsically hollow aspect of the data.

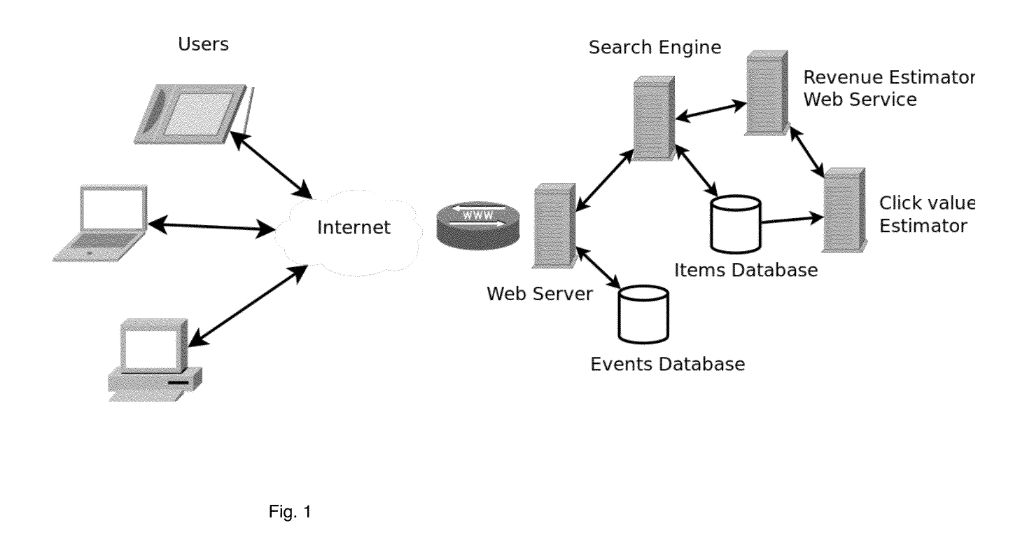

FIG. 1 illustrates a typical environment in which the invention may be implemented. The user (not shown in FIG. 1) accesses the Search Engine by sending requests (not shown in FIG. 1) over the Internet via the Web Server, the requests being entered for example on a Personal Computer, a Laptop or a Tablet Computer as illustrated to the left hand side of FIG. 1. As is known in the art, the Web Server, Personal Computer, Laptop, and Tablet Computer may comprise hardware, such as storage to hold the operative software and a processor to execute the software. The users interactions with the webpage are stored in the event database. The search engine of the computing system exchanges information with the item database, in order to provide a results list. (Both databases may reside on hardware of the computing system.) A Revenue web service server further registers information produced by the Search Engine and may provide instructions to the Search Engine to influence the manner in which the search results need to be presented. The Revenue web service server also accesses the event database and interacts with a Click value estimator server, according to methods and processes explained in the present specification.

Notations
A(r,i) is the number of clicks at position r on item i
C(r,i) is the number of displays at position r on item i
B(r,i)=C(r,i)−A(r,i) is the number of non-clicks at position r on item i
A(.i)=ΣrA(r,i) is the number of clicks on item i
C(.i)=ΣrC(r,i) is the number of displays on item i
B(.i)=C(.i)−A(.i) is the number of non-clicks on item i
A(r.)=ΣiA(r,i) is the number of clicks at position r
C(r.)=ΣiC(r,i) is the number of displays at position r
B(r.)=C(r.)−A(r.) is the number of non-clicks at position r
v(r) is the probability of an item to be viewed at position r
s(i) is the conditional probability, knowing the position at which the item i has been displayed, of a click on item i
Pr(X) is the probability of the variable X

Definitions

Expected revenue

Expected item revenue: unitary revenue [see definition hereunder]*click probability [see definition hereunder].

Expected page revenue: Sum of the expected item revenue [as defined herein above].

Item (unitary) revenue

Revenue associated with the action of clicking on a particular item.

Click probability of an item

Proportion of times a user clicks on an item on average

General Methodology

Several automated learning techniques against the historical users interactions data [see training and test samples] are successively applied [see methods hereunder], either on one of the pieces of data previously produced, or on the baseline [see hereunder]. We distinguish in particular 5 predictors types:
noem predictor: basic application of the baseline
em predictor: application of EM method alone
noem-noem: application of Bayesian method on baseline probabilities, smoothed with baseline probabilities
noem-em: application of Bayesian method on baseline probabilities, smoothed with EM probabilities
em-em: application of Bayesian method on EM probabilities, smoothed with EM probabilities

Each predictor can be further refined with application of method 3 and 4 [see hereunder]. The results are cross-validated and compared [see Comparison of models]. Only the best predictor is kept for each process [see Methods and Processes].

Comparison of Models

A total order between models is defined.

Mean and confidence interval are analyzed.

In case of an overlapping confidence interval, the model which has the minimum valued interval is said smaller than the other

In case of inclusion, the model which has the smallest confidence interval is said smaller than the biggest

Training and Test Sample

The historical data may be divided in parts, either randomly or sliced according to the timestamps.

A set of training data is defined.

A set of test data is defined.

Baseline

Click probabilities are estimated by the formula ‘number of clicks on the item divided by the number of item displays’, that is with our notations:

Pr(i)=A(i)/C(i)

If no display is available, a default probability is applied.

Method 1: ‘Taking into Account the Position of the Item in the Result Set’

Parameters are associated with each value of property at the current bucket level [see Search for the optimal configuration].

Items are associated to their parameters.

Pr(item)=Pr(position)*Pr(parameter)

EM Method to Separate the Effect of the Position with the Effect of the Parameter Configuration Choice for the Item Associated to a Parameter

An estimation metric of the configuration quality is proposed [see choice of metrics hereunder]. An optimal configuration search algorithm is proposed [see Search for optimal frequential cut-off values].

Both propositions are now explained.

Choice of Metrics

Several metrics are defined, each one corresponding to the resolution of a specific problem. For example the optimization of the prediction of revenue per page, the optimization of the prediction of click probability per page, the optimization of the prediction of the best ranking per page, the optimization of the prediction of the best ranking per item and the impact on the revenue.

For example,

M=(#predicted_clicks−#observed_clicks)/#observed_clicks

RM=(#predicted_revenue−#observed_revenue)/#observed_revenue

Search for the Optimal Configuration

Ordered buckets are defined from the common properties of items, for example the buckets Item, Category x Site, Category, Site, in that order. For each bucket, in order of their definitions, a specific parameter is associated with all the items where the frequency of the historical events is greater than the defined value. The items that do not meet any frequency conditions for any buckets are associated to a unique generic parameter. A search procedure in the hypercube of frequency values is proposed.

Search for Optimal Frequential Cut-Off Values

For each dimension, a search is carried out, logarithmic in space, increasing or decreasing. The cut-off for a dimension corresponding to the best metric is kept. The exploration procedure of the value frequency is repeated for each dimension by fixing the preceding dimension. The procedure is stopped if the difference between the two consecutive metric values, or the best found at this stage, is inferior to a certain value, given by the method operator.

‘EM’ Method

Analytic equations of couplings between Pr(position) and Pr(parameter) are created.

vn+1(r)=(A(r.)+˜Bn (r.))/C(r.)

sn+1(p)=A(.p)/(A(.p)+˜B(.p))

where

X(r.)=Σp {X(r,p)}, X(.p)=Σr {X(r,p)}, and

˜Bn (r,p)=B(r,p)*vn (r)*(1−sn (p))/(1−vn (r)*sn (p))})

For each parameter of the configuration choice [see section herein above], the values of Pr(position) and Pr(parameter) are estimated by the coupling equations [from the previous paragraph], then re-estimated until the convergence process as explained in the following paragraph.

The convergence process is defined below:
by the number of sufficient steps,
by a delta of metric values [see choice of metrics herein above] inferior to a cut-off, given by the method operator.

The click probability is defined by:

F(r,i)=v(r)*s(i)

Method 2: ‘Taking into Account the Hollow Aspect of the Historical Data’Bayesian method with a beta prior.

The probability is estimated by ˜p(i)=(A(i)+a)/(C(i)+c) where a,c are the beta distribution parameters

a=˜E(p)*c

c=(˜E(p)*(1−˜E(p))/˜V(p))−1
where ˜E(p) (resp. ˜V(p)) are estimates of mean (resp. variance) of beta distribution.

Buckets are described in a similar way as explained herein above in the section Search for the optimal configuration. For each bucket, following the order of the properties as defined during the defining of ordered buckets [see section Search for the optimal configuration], a set of ascending and descending priorities is defined. For each bucket, a local predictor is the disjointed union of a high predictor and a low predictor. This separation is carried out following the frequency of items checking the properties, estimated on a history of user actions. A local bucket predictor is either a baseline predictor calculated from one of the descending properties of the bucket, or an EM predictor issued from the method 1, possibly combined with an ascending property using a Bayesian method. An exhaustive search procedure of the local predictor is given. The search procedure of the frequential cut-off [as explained for method 1] is applied.

Method 3: ‘Robustification of Predictors’

This method is applied to the predictors of the method 2.

The predictor application process is proposed: the number of items per bucket [see explanation about ordered bucket under method 1] which uses a particular local predictor [local predictor term is explained under method 2].

If the application profile of a particular bucket is smaller than the cut-off, given by the method operator, then this predictor is replaced by a generic default predictor.

Method 4 ‘Local and Global Recalibration’

This method can be applied as a compliment to all other previous methods. Recalibration is done by re-estimating all probabilities on a new set of historical user actions. Local recalibration is carried out by learning the default probability parameter. Global recalibration is carried out on the probabilities of all parameters.

Probability of Click of a Page

The click probability of a page is explained analytically from the individual probability of each item.

The present invention is not intended to be limited solely to the embodiments described and/or illustrated herein. To the contrary, there are numerous variations and equivalents that should be apparent to those skilled in the art based upon the embodiment(s) described and/or illustrated herein. Those variations and equivalents are intended to be encompassed by the present invention

1. A method in a computing system for estimating probabilities of a user clicking on items appearing in a results list obtained by a web search engine in order to predict the revenue for the results list, the web searching engine being used by the user to search for the items on the web,
the results list comprising a plurality of items,
each of the items of the plurality of items having one or more properties, whereby at least one of the one or more properties may be common between the item and an other item, and whereby the one or more properties each have a determined value,
whereby historical data of users' actions comprises at least for each of the plurality of items or for a set of the plurality of items, a list of displays and clicks on selected items together with their values of properties if available, thus allowing the aggregation of statistics of displays and clicks for each values of properties, such as the frequency of appearance at which users have selected the item in a past period and a total number of appearances at which users have selected the item in the past period,
the method comprising the following steps:
defining an ordered set of buckets that each may contain one or more items of the plurality of items, whereby the one or more items are selected if they respectively have a subset of properties corresponding to a bucket specific subset of properties and if they respectively satisfy a criteria on their number of appearances in the historical data;
computing, using a processor in the computing system, a bucket specific analysis for each bucket to produce a model;
repeating the step of defining an ordered set of buckets and the step of computing a bucket specific analysis to obtain the model until a result of the statistical analysis reaches a determined threshold of convergence; and
computing, using a processor in the computing system, a refinement of the model using a statistical analysis.

2. The method of claim 1, wherein
the step of computing a bucket specific analysis is performed for a first bucket and a second bucket, whereby a first statistical analysis is applied for the first bucket, and a second statistical analysis is applied for the second bucket, the second statistical analysis being different from the first statistical analysis;
the method further comprising
combining the first bucket specific analysis with the second bucket specific analysis by applying the step of computing a bucket specific analysis to the combination of the first bucket specific analysis and the second bucket specific analysis using a third statistical analysis.

3. The method of claim 2, wherein
the first statistical analysis is one of the list comprising a baseline, an EM based method;
the second statistical analysis is one of the list comprising a baseline, an EM based method;
the third statistical analysis is a Bayesian based method.

4. The method of claim 1, wherein
the step of computing a bucket specific analysis is performed using a statistical analysis.

5. The method of claim 4, wherein
the statistical analysis is one of the list comprising a baseline method, an EM based method.

6. The method of claim 1, wherein
the step of repeating the step of defining one or more buckets and the step of computing a bucket specific analysis to obtain the model are performed using a statistical analysis that comprises a successive usage of a method for searching for an optimal configuration and a method for searching for optimal frequential cut-off values;
the method further comprising
an associating for each item to a parameter used to aggregate statistics on the user historical data for each value of properties; and
carrying out a searching for each dimension, logarithmic in space, increasing or decreasing, until the difference between the two consecutive metric values, or the best found at this stage, is inferior to a certain value, given by the method operator.

7. The method of claim 2, wherein
the step of computing a refinement of the model is performed by a statistical analysis, the latter comprising a method for local and global recalibration of probabilities/revenues and a method for robustification of probabilities/revenues predictors.

8. The method of claim 7, wherein the method for local and global recalibration further comprises
re-estimating all probabilities on a new set of historical user actions,
carrying out the local recalibration by learning the default probability parameter; and
carrying out the global recalibration on the probabilities of all parameters.

9. The method of claim 7, wherein the method for robustification further comprises
a review of the number of items per bucket which uses a particular local predictor to build an application profile; and
a use of a cutoff per bucket to replace the predictor by a generic default predictor.

10. The method of claim 3, further comprising the use of a baseline method, wherein
the probabilities are estimated using the number of clicks on items corresponding to a parameter divided by the number of item displays corresponding to this parameter and the revenues by multiplying the latter with the revenue per click; and
wherein the parameter is used to aggregate statistics on the user historical data for each value of properties.

11. The method of claim 3, further comprising the use of an EM based method, wherein the probabilities Pr of each item are estimated using the equation
Pr(item)=Pr(position)*Pr(parameter)
where Pr(position) and Pr(parameter) are estimated using the iterative calculation of a coupling equation, which states
vn+1(r)=(A(r.)+˜Bn (r.))/C(r.)
sn+1(p)=A(.p)/(A(.p)+˜B(.p))
where
X(r.)=Σp {X(r,p)}, X(.p)=Σr {X(r,p)}, and
˜Bn (r,p)=B(r,p)*vn (r)*(1−sn (p))/(1−vn (r)*sn (p))}).

12. The method of claim 3 further comprising the use of a Bayesian based method, wherein
the Bayesian method is carried out using a beta prior, with the following probability estimation calculation: ˜p(i)=(A(i)+a)/(C(i)+c) where a, c are the beta distribution parameters
a=˜E(p)*c
c=(˜E(p)*(1−˜E(p))/˜V(p))−1
where ˜E(p) (resp. ˜V(p)) are estimates of mean (resp. variance) of beta distribution.

13. The method of claim 6, wherein the associating is done through the use of a local predictor, the latter further comprising the determination of a low and a high parameter, the choice of parameter being resolved with the number of appearances for a particular value of property associated with the item.

14. The method of claim 6, wherein the metric is done by the formula (#predicted_clicks−#observed_clicks)/#observed_clicks for probability estimation and by the formula (#predicted_revenue−#observed_revenue)/#observed_revenue for revenue estimation.

15. The method of claim 11, wherein the parameters are one of the values of property that are known for the bucket.

16. The method of claim 12, wherein the mean and variance of beta distribution are estimated on items for each bucket smaller than another bucket, according to the ordered set of buckets.

17. The method of claim 5, further comprising the use of a baseline method, wherein
the probabilities are estimated using the number of clicks on items corresponding to a parameter divided by the number of item displays corresponding to this parameter and the revenues by multiplying the latter with the revenue per click; and
wherein the parameter is used to aggregate statistics on the user historical data for each value of properties.

18. The method of claim 5, further comprising the use of an EM based method, wherein the probabilities Pr of each item are estimated using the equation
Pr(item)=Pr(position)*Pr(parameter)
where Pr(position) and Pr(parameter) are estimated using the iterative calculation of a coupling equation, which states
vn+1(r)=(A(r.)+˜Bn (r.))/C(r.)
sn+1(p)=A(.p)/(A(.p)+˜B(.p))
where
X(r.)=Σp {X(r,p)}, X(.p)=Σr {X(r,p)}, and
˜Bn (r,p)=B(r,p)*vn (r)*(1−sn (p))/(1−vn (r)*sn (p))}).

19. The method of claim 18, wherein the parameters are one of the values of property that are known for the bucket.
